(19) United States
(12) Patent Application Publication
(10) Pub. No.: US 2025/0373656 A1
(43) Pub. Date: Dec. 4, 2025

(54) FOUNDATIONAL MACHINE LEARNING MODEL APPLICATION PROGRAMMING INTERFACE (API) SECURITY

(71) Applicant: Cequence Security, Inc., Sunnyvale, CA (US)

(72) Inventors: Abraham Jeevagunta, San Jose, CA (US); Rohit Unnikrishnan, Sunnyvale, CA (US); Khyati Ganatra, Santa Clara, CA (US); Shreyans Mehta, Los Altos, CA (US)

(21) Appl. No.: 19/220,386

(22) Filed: May 28, 2025

Related U.S. Application Data
(60) Provisional application No. 63/655,456, filed on Jun. 3, 2024.

(51) Int. Cl. H04L 9/40; G06F 9/54

(52) U.S. Cl. CPC H04L 63/1466; G06F 9/547; H04L 63/1458

(57) ABSTRACT

Various embodiments include a system. The system comprises processing circuitry. The processing circuitry obtains an Application Programming Interface (API) call that is associated with a Large Language Model (LLM). The processing circuitry generates a feature vector that numerically represents data included in the API call associated with the LLM. The processing circuitry provides the feature vector to a security LLM trained to detect security threats to the LLM. The processing circuitry obtains an output from the security LLM that indicates a security threat to the LLM. The processing circuitry determines a security policy based on the security threat. The processing circuitry provides the security policy to a security proxy that screens the API call.

### CROSS-REFERENCE TO RELATED APPLICATIONS

This U.S. Patent application claims the benefit of and priority to U.S. Provisional Patent Application 63/655,456 titled, “LARGE LANGUAGE MODEL (LLM) APPLICATION PROGRAMMING INTERFACE (API) SECURITY” which was filed on Jun. 3, 2024, and which is hereby incorporated by reference into this U.S. patent application in its entirety.

### TECHNICAL FIELD

Various embodiments of the present technology relate to Application Programming Interface (API) Security, and more specifically, to API based security for foundational machine learning models.

### BACKGROUND

The security of a web service is of upmost importance to both the operators of the website and its users. As Internet communications expand for business transactions and other services, more threats to website security arise. Website owners, insurers, hosting services, and others involved in the provisioning of a web service typically strive to create a robust security infrastructure for a website to prevent nefarious individuals from compromising the site. However, despite these security precautions, a website could still be subject to intrusions by computer hackers, malware, viruses, and other malicious attacks. Websites may be vulnerable to security breaches for a variety of reasons, including security loopholes, direct attacks by malicious individuals or software applications, dependencies on compromised third-party providers, and other security threats. Security systems are employed by websites to counteract the wide range of threats.

Many web applications utilize Application Programming Interface (API) based applications for functions like sales productivity, collaboration, marketing automation, and project tracking. API usage has increased as organizations have expanded their use of microservices and created new cloud-native applications. The consumer facing applications that the organizations create are often API based. This API ecosystem is fueled by increases in public cloud environments, Kubernetes environments, serverless environments, and use of third-party Software As A Service (SaaS) systems. Developers may roll out new API driven services in any environment. Critical information like personal information, financial information, health information, and the like is stored behind the applications that host these APIs. Malicious actors often utilize APIs as entry points to perform unwanted actions (e.g., obtaining sensitive data). It is difficult for security systems to counter malicious actors given the large and increasing number of APIs.

Machine learning models are designed to recognize patterns, produce recommendations, and automatically improve through training and the use of data. Examples of machine learning models include foundational models, Large Language Models (LLMs), artificial neural networks, nearest neighbor methods, gradient-boosted trees, ensemble random forests, support vector machines, naïve Bayes methods, and linear regressions. Machine learning models are trained using training data sets. During the training process, the models process the training data and produce training outputs. The model's operators or the models themselves compare the training outputs to expected outputs and adjust their constituent machine learning algorithms to achieve desired output accuracy. Once trained, the models may ingest live data and process the live data using their trained algorithms to produce recommendations, predictions, and the like.

Large Language Models (LLMs) are a class of machine learning model with capabilities to process and generate human-like text. This capability provides immense value across various sectors including healthcare, finance, education, and customer service. Despite their benefits, LLMs face significant security challenges that threaten the integrity, privacy, and reliability of the data they process and generate. LLMs are often accessed through APIs. However, the use of publicly available APIs creates significant security challenges for the LLMs that threaten their integrity, privacy, and reliability of the data they process and generate. For example, malicious entities may exploit an API for an LLM to leak sensitive data, produce unwanted LLM outputs using prompt injection attacks, poison training data, drive the LLM to perform computationally intensive operations to perform denial-of-service attacks, and the like. Unfortunately, computing environments that host LLMs do not effectively or efficiently secure the LLMs against API based attacks.

### Overview

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to providing security to foundational machine learning models like Large Language Models (LLMs). Some embodiments comprise a method. The method comprises obtaining an Application Programming Interface (API) call that is associated with an LLM. The method further comprises generating a feature vector that numerically represents data included in the API call associated with the LLM. The method further comprises providing the feature vector to a security LLM trained to detect security threats to the LLM. The method further comprises obtaining an output from the security LLM that indicates a security threat to the LLM. The method further comprises determining a security policy based on the security threat. The method further comprises providing the security policy to a security proxy that screens the API call.

Some embodiments comprise a system. The system comprises processing circuitry. The processing circuitry obtains an API call that is associated with an LLM. The processing circuitry generates a feature vector that numerically represents data included in the API call associated with the LLM. The processing circuitry provides the feature vector to a security LLM trained to detect security threats to the LLM. The processing circuitry obtains an output from the security LLM that indicates a security threat to the LLM. The processing circuitry determines a security policy based on the security threat. The processing circuitry provides the security policy to a security proxy that screens the API call.

Some embodiments comprise one or more non-transitory computer readable storage media having program instructions stored thereon. The program instruction, when executed by a computing system, direct the computing system to perform operations. The operations comprise obtaining API calls addressed for an LLM and API responses produced by the LLM. The operations further comprise generating feature vectors that numerically represent data included in the API calls addressed for the LLM and API responses produced by the LLM. The operations further comprise providing the feature vectors to a security LLM trained to detect security threats to the LLM. The operations further comprise obtaining an output from the security LLM that indicates a security threat to the LLM. The security threat comprises at least one of a sensitive data leak, a prompt injection attack, data poisoning, insecure output handling, a denial-of-service attack, a permission issue, excessive agency, or an insecure plugin. The operations further comprise determining a security policy based on the security threat. The operations further comprise providing the security policy to a security proxy that screens the API calls addressed to the LLM and the API responses produced by the LLM.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system to provide security to foundational machine learning models.

FIG. 2 illustrates an exemplary operation of the system to provide security to foundation machine learning models.

FIG. 3 illustrates a system to provide security to Large Language Models (LLMs).

FIG. 4 illustrates an example of a Large Language Model (LLM) Application Programming Interface (API) security system to provide security to LLMs.

FIG. 5 illustrates an exemplary sensitive data detection process to provide security to LLMs.

FIG. 6 illustrates an exemplary API request and response analysis process to provide security to LLMs.

FIG. 7 illustrates an example of a computing device that may be used in accordance with various embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Security of Artificial Intelligence (AI) systems is a dynamic field. The state-of-the-art continually evolves at a fast pace as AI is applied to a wider range of sectors and application domains. AI provides opportunities to both security systems and malicious actors. AI introduces new risks to business processes and data security. AI introduces risks to personal safety when used in cyber-physical systems like self-driving vehicles, autonomous drones, and the like. The rapid and expanding adoption and impact of AI across many economic sectors and technologies is pushing AI further up global regulatory agendas that seek to gain a handle on the security, safety, and ethics challenges associated with AI use.

The integration of Large Language Models (LLMs) into online platforms presents a double-edged sword. LLMs offer enhanced user experiences but also introduce security vulnerabilities. Insecure output handling is a prominent concern. Insecure output handling occurs when LLM outputs are not sufficiently validated or sanitized which can lead to a range of exploits like Cross-Site Scripting (XSS) and Cross-Site Request Forgery (CSRF). Indirect prompt injection is another threat that further exacerbates these risks. Indirect prompt injection allows attackers to manipulate LLM responses through external sources such as training data or Application Programming Interface (API) calls. This may result compromise user interactions and system integrity. Additionally, training data poisoning poses a significant threat. Compromised (i.e., poisoned) training data used in model training may result in the dissemination of inaccurate or sensitive information which undermines trust and security.

To address the above describe problems, various embodiments of the present technology relate to defending against LLM attacks by utilizing a multifaceted approach that prioritizes robust security measures and proactive risk mitigation strategies. The approach treats LLM-accessible APIs as publicly accessible entities, implements stringent access controls, and avoids feeding sensitive data to LLMs to bolster LLM defense. Furthermore, relying solely on prompting to block attacks is insufficient. Attackers may circumvent prompt restrictions through cleverly crafted prompts. This underscores the need for comprehensive security protocols that encompass API data sanitization, API access control, and ongoing API vulnerability testing. By adopting these practices, organizations can safeguard their systems and user data against the evolving threat landscape posed by LLM-based attacks.

The use of forward and reverse proxy solutions in managing API traffic offers distinct advantages and unique features tailored to different operational contexts. A forward proxy, deployed closer to the client or user side, serves as a gateway for private APIs or outbound traffic. This approach enhances security, privacy, and control over internal network requests to external services. By masking the Internet Protocol (IP) addresses of clients within a private network, a forward proxy reduces the exposure to external threats and mitigates the risk of direct attacks. The forward proxy also enables centralized access control and traffic monitoring. This ensures that outbound requests comply with organizational policies and internet usage guidelines making it particularly advantageous for organizations looking to safeguard their internal network while managing outbound internet access.

Conversely, a reverse proxy is situated closer to the server side and acts as an intermediary for incoming requests from external clients to public APIs. This setup provides an essential layer of abstraction and control for public-facing web applications which enhances security, load balancing, and Secure Socket Layer (SSL) termination. By distributing client requests efficiently among several servers, a reverse proxy not only optimizes resource utilization and ensures application scalability but also fortifies the application by concealing the identities and configurations of backend servers. This approach significantly mitigates risks such as Distributed Denial-of-Server (DDOS) attacks and web vulnerabilities to ensure a secure, robust, and high-performing public API service. Together, these proxy-based approaches provide comprehensive security and management solutions for both outbound and inbound API traffic. These proxy-based approaches cater to the distinct needs of private and public API interactions while ensuring operational efficiency, scalability, and enhanced security posture. Now referring to the Figures.

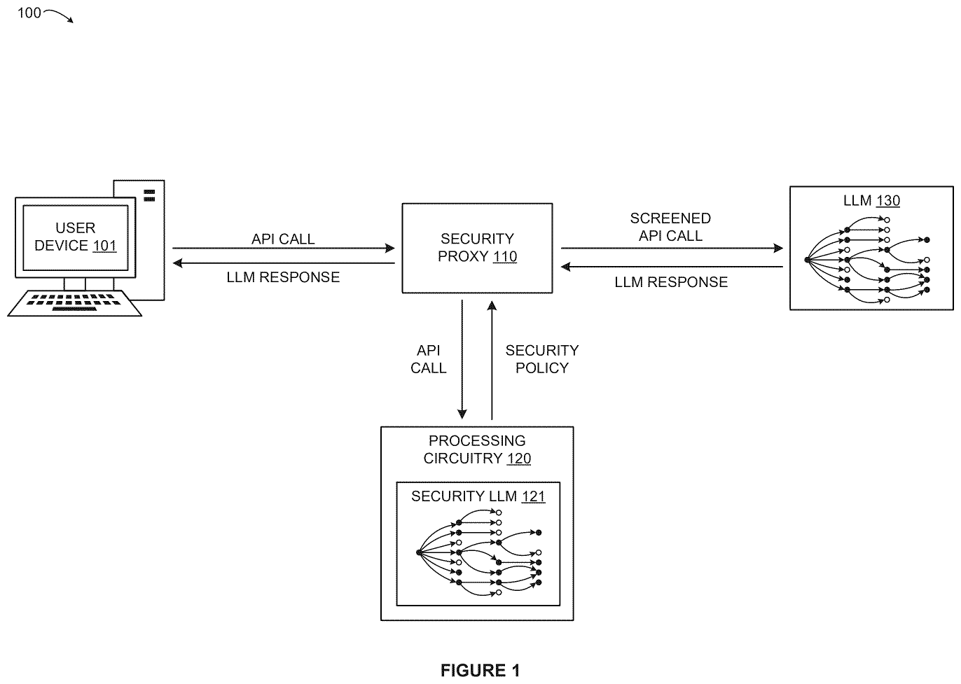

FIG. 1 illustrates system 100 to provide security to foundational machine learning models like LLMs that utilize APIs. System 100 provides services like online networking, content distribution, web application services, web application security, machine learning, and the like. System 100 comprises user device 101, security proxy 110, processing circuitry 120, and LLM 130. Processing circuitry 120 comprises security LLM 121. In other examples, system 100 may comprise additional or different elements than those illustrated in FIG. 1. Likewise, the illustrated components of system 100 may include fewer or additional components, assets, or connections than shown. User device 101, security proxy 110, processing circuitry 120, and LLM 130 may be representative of a single computing apparatus or multiple computing apparatuses.

Various examples of system operation and configuration are described herein. In some examples, user device 101 transfers an API call associated with LLM 130. Security proxy 110 intercepts the API call before delivery to LLM 130 and provides the API call (or data characterizing the API call) to process circuitry 120. Processing circuitry 120 is representative of one or more computing devices that host or otherwise implement security systems (e.g., security LLM 121) to protect LLM 130 from malicious inputs. Processing circuitry 120 obtains the API call associated with LLM 130 and generates a feature vector that numerically represents the data included in the API call. Processing circuitry 120 provides the feature vector to security LLM 121. Security LLM 121 is representative of one or more LLMs or other types of machine learning models trained to detect security threats to LLM 130 and/or other types of foundational machine learning models. Security LLM 121 processes the feature vector and produces an output that indicates a security threat to LLM 130. For example, the security threat may comprise a sensitive data leak, a prompt injection attack, data poisoning, insecure output handling, a denial-of-service attack, a permission issue, excessive agency, an insecure plugin, and the like. Processing circuitry 120 obtains the output from security LLM 121 and determines a security policy based on the identified threat(s). For example, if security LLM 121 produces an output indicating a prompt injection attack, processing circuitry 120 may generate security policies to block API calls with characteristics associated with the prompt injection attack. Processing circuitry 120 provides the security policy to security proxy 110. Security proxy 110 applies the security policy to screen the API call addressed to LLM 130. LLM 130 receives the screened API call and produces an LLM response based on the payload included in the screened API call. LLM 130 provides the LLM response to user device 101 via security proxy 110. Additionally, security proxy 110 may apply the security policies to block erroneous or otherwise unwanted outputs produced by LLM 130. Advantageously, system 100 effectively and efficiently secures LLMs and/or other types of foundational machine learning models against API based attacks.

In some examples, processing circuitry 120 may train security LLM 121 to identify security threats to LLM 130. Processing circuitry 120 may obtain training data from security proxy 110. For example, a database (not illustrated) associated with security proxy 110 may store training data that characterizes historic API calls in association with historic security threats to LLM 130. Processing circuitry 120 generates one or more training feature vectors that numerically represent the training data (e.g., the historical API calls and/or historical security threats to LLM 130). Processing circuitry 120 provides the one or more training feature vectors to the security LLM 121 to train security LLM 121 to detect security threats to LLM 130. Security LLM 121 processes the one or more training feature vectors to predict the security threats based on the payloads of the historic API calls (and/or responses). Processing circuitry 120 obtains a training output from security LLM 121 that predicts the historical security threats. Processing circuitry 120 determines a training state of security LLM 121 based on the accuracy of the prediction. For example, human operators and/or processing circuitry 120 may compare the predicted security threats to the actual historical security threats to determine the accuracy of the predictions. When the accuracy of the predictions exceeds an operator defined threshold, processing circuitry 120 pushes security LLM 121 to production.

LLM 130 is representative of a foundational machine learning model to generate recommendations, make predictions, and/or perform some other type of machine learning assisted task. Similarly, security LLM 121 is representative of a machine learning model trained to detect security threats to LLM 130. A machine learning model comprises one or more machine learning algorithms that are trained to produce outputs based on historical data and/or other types of training data. A machine learning model may employ one or more machine learning algorithms through which data can be analyzed to identify patterns, make decisions, make predictions, or similarly produce output. While illustrated as comprising LLMs, in other examples LLMs 121 and 130 may comprise other types of machine learning models. For example, LLMs 121 and 130 may alternatively comprise Three Dimensional (3D) deep leaning models, 3D convolutional neural networks, times series convolutional deep learning, transformers, multi-layer perceptron, long term short memory, attention based deep learning model, artificial neural networks, nearest neighbor methods, ensemble random forests, support vector machines, naïve Bayes methods, linear regressions, or similar machine learning techniques or combinations thereof capable of predicting output based on input data.

While user device 101 is illustrated as comprising a personal computer, user device 101 may comprise another device with data communication circuitry like a smartphone, a server computer, a sensor, a drone, a vehicle, and the like. User device 101, security proxy 110, processing circuitry 120, and LLM 130 communicate over communication systems like routers, gateways, telecommunication switches, servers, processing systems, or other communication equipment and systems for providing communication and data services. The communication systems could comprise wireless communication nodes, telephony switches, Internet routers, network gateways, computer systems, communication links, or some other type of communication equipment, including combinations thereof. The communication systems may also comprise optical networks, packet networks, local area networks (LAN), metropolitan area networks (MAN), wide area networks (WAN), or other network topologies, equipment, or systems, including combinations thereof. User device 101, security proxy 110, processing circuitry 120, and LLM 130 may communicate over wired or wireless communication links. The communication links that connect the elements of system 100 use metallic links, glass fibers, radio channels, or some other communication media. The communication links may use Internet Protocol (IP), Time Division Multiplex (TDM), Data Over Cable System Interface Specification (DOCSIS), IP, General Packet Radio Service Transfer Protocol (GTP), Institute of Electrical and Electron Engineers (IEEE) 802.11 (Wifi), IEEE 802.3 (Ethernet), optical networking, wireless protocols, communication signaling, virtual switching, inter-processor communication, bus interfaces, or some other communication format, including combinations thereof.

User device 101, security proxy 110, processing circuitry 120, and LLM 130 comprise microprocessors, software, memories, transceivers, bus circuitry, and the like. The microprocessors comprise Central Processing Units (CPU), Graphical Processing Units (GPU), Application-Specific Integrated Circuits (ASIC), Field Programmable Gate Array (FPGA), and/or types of processing circuitry. The memories comprise Random Access Memory (RAM), Solid State Drives (SSDs), Hard Disk Drives (HDDs), Non-Volatile Memory Express (NVMe) SSDs, and/or the like. The memories store software like operating systems, security modules, machine learning models, user applications, web applications, and browser applications. The microprocessors retrieve the software from the memories and execute the software to drive the operation of system 100 as described herein.

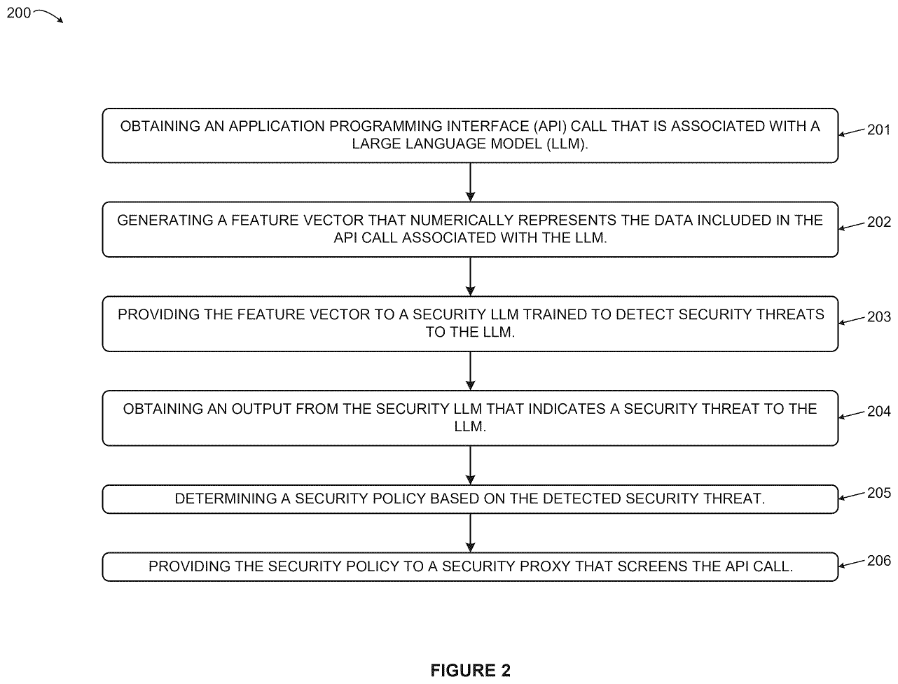

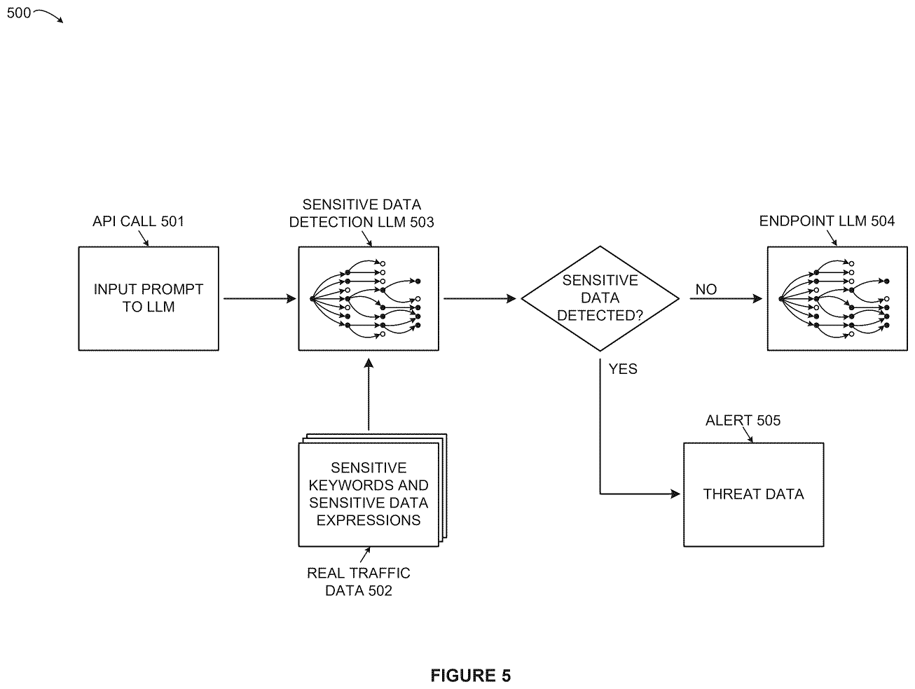

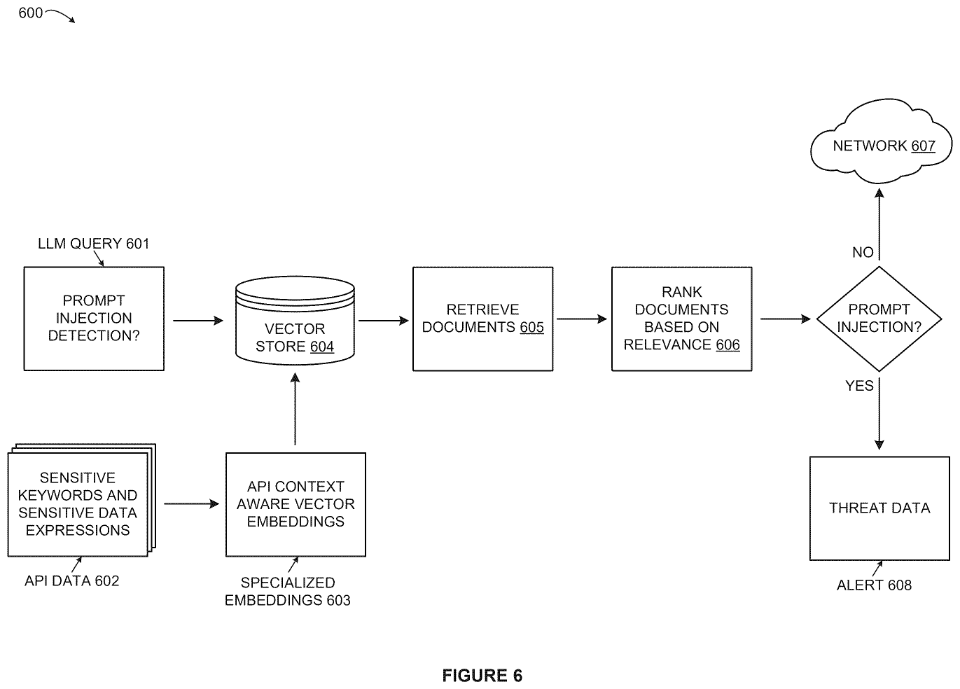

In some examples, system 100 implements process 200 illustrated in FIG. 2, process 500 illustrated in FIG. 5, and/or process 600 illustrated in FIG. 6. It should be appreciated that the structure and operation of system 100 may differ in other examples.

FIG. 2 illustrates process 200. Process 200 comprises an exemplary operation of system 100 to provide security to foundation machine learning models like LLMs. Process 200 comprises an example of process 500 illustrated in FIG. 5 and process 600 illustrated in FIG. 6, however processes 500 and 600 may differ. Process 200 may vary in other examples. The operations of process 200 comprise obtaining (e.g., by processing circuitry 120) an API call that is associated with an LLM (e.g., LLM 130) (step 201). The operations further comprise generating a feature vector that numerically represents the data included in the API call associated with the LLM (step 202). The operations further comprise providing the feature vector to a security LLM (e.g., security LLM 120) trained to detect security threats to the LLM (step 203). The operations further comprise obtaining an output from the security LLM that indicates a security threat to the LLM (step 204). For example, the security threat may comprise one or more of a sensitive data leak, a prompt injection attack, data poisoning, insecure output handling, a denial-of-service attack, a permission issue, excessive agency, an insecure plugin, and the like. The operations further comprise determining a security policy based on the detected security threat (step 205). The operations further comprise providing the security policy to a security proxy (e.g., security proxy 110) that screens the API call (step 206).

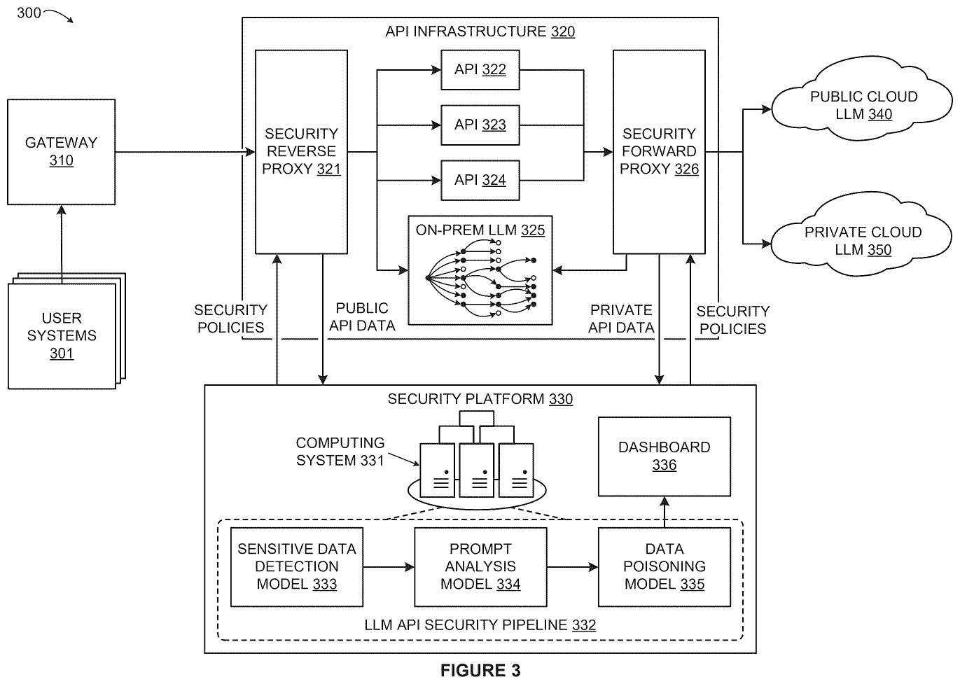

FIG. 3 illustrates system 300 to provide security to foundational machine learning models like LLMs that utilize APIs. System 300 comprises an example of system 100 illustrated in FIG. 1, however system 100 may differ. System 300 comprises user systems 301, gateway 310, API infrastructure 320, security platform 330, public cloud LLM 340, and private cloud LLM 350. API infrastructure 320 comprises security reverse proxy 321, APIs 322-324, on-premises (ON-PREM) LLM 325, and security forward proxy 326. Security platform 330 comprises computing system 331 and dashboard 336. Computing system 331 hosts LLM API security pipeline 332. LLM API security pipeline 332 comprises sensitive data detection model 333, prompt analysis model 334, and data poisoning model 335. In other examples, system 300 may comprise additional or different elements than those illustrated in FIG. 3. Likewise, the illustrated components of system 300 may include fewer or additional components, assets, or connections than shown. User systems 301, gateway 310, API infrastructure 320, security platform 330, public cloud LLM 340, and private cloud LLM 350 may be representative of a single computing apparatus or multiple computing apparatuses.

User systems 301 are computing systems that generate and transfer API calls for LLM 325, public cloud LLM 340, and/or private cloud LLM 350. User systems 301 comprise examples of user device 101 illustrated in FIG. 1, however user device 101 may differ. The API calls typically comprise natural language LLM inputs. Exemplary LLM inputs include natural language content creation requests, market research requests, competitor analysis requests, general-purpose chatbot requests, customer service chatbot requests, translation requests, computer code generation requests, personalized marketing requests, customer analysis data requests, education requests, healthcare requests, financial requests, legal requests, media requests, military/defense requests, and the like. Examples of user systems 301 include mobile computing devices, such as cell phones, tablet computers, laptop computers, notebook computers, and gaming devices, as well as any other type of mobile computing devices and any combination or variation thereof. Examples of user systems 301 also include smartphones, desktop computers, server computers, virtual machines, sensors, drones, vehicles, as well as any other type of computing system, variation, or combination thereof. User stems 301 may be representative of human controlled systems (e.g., a smartphone) or automated systems (e.g., a bot).

Gateway 310 is a computing system that routes the API calls intended for LLMs 326, 340, and/or 350 to ones of APIs 322-324 in infrastructure 320. Examples of gateway 310 include Content Deliver Network (CDN) gateways, API gateways, default gateways, media gateways, payment gateways, Voice Over Internet Protocol (VOIP) gateways, residential gateways, enterprise gateways, cloud gateways, IoT gateways, as well as any other type of gateway computing devices and any combination or variation thereof. Examples of gateway 310 also include desktop computers, server computers, and virtual machines, as well as any other type of computing system, variation, or combination thereof.

API infrastructure 320 is representative of an enterprise computing environment. Examples of API infrastructure 320 may include server computers and data storage devices deployed on-premises, in the cloud, in a hybrid cloud, or elsewhere, by service providers such as enterprises, organizations, individuals, and the like. API infrastructure 320 may rely on the physical connections provided by one or more other network providers such as transit network providers, Internet backbone providers, and the like to communicate with and provide services to external systems. In some examples, the computing systems of API infrastructure 320 could comprise a web server, CDN, forward/reverse proxy, load balancer, middleware, cloud server, network switch, router, switching system, packet gateway, network gateway system, Internet access node, application server, database system, service node, firewall, or some other communication system, including combinations thereof.

APIs 322-324 are representative of a set of API servers, computing systems, and/or network equipment configured to provide services and web resources to clients and/or operators of infrastructure 320. In particular, APIs 322-324 route LLM inputs included in API requests received from user systems 301 to LLMs 325, 340, and/or 350. APIs 322-324 may additionally generate and transfer API calls that include LLM inputs generated by operators of API infrastructure 320 to on-premises model 325, public cloud LLM 340, and private cloud LLM 350. APIs 322-324 may comprise client-side APIs and server-side APIs. APIs 322-324 may be representative of any computing apparatus, system, or systems that may connect to another computing system over a communication network. Some examples of computing systems that host APIs 322-324 include database systems, server computers, cloud computing platforms, and virtual machines, as well as any other type of computing system, variation, or combination thereof. The API servers may be in various environments like the cloud, Kubernetes, serverless, data center, and the like.

Security reverse proxy 321 and security forward proxy 326 are representative of servers, computing systems, and/or network equipment to enforce security policies on API calls received and transferred by API infrastructure 320. Security proxies 321 and 326 comprise examples of security proxy 110 illustrated in FIG. 1, however security proxy 110 may differ. Reverse proxy 321 applies security policies generated by security platform 330 to API calls generated by user systems 301 and received over gateway 310. Forward proxy 326 applies security policies generated by security platform 330 to API calls generated within API infrastructure 320 for LLMs 325, 340, and 350. The security policies block malicious or otherwise unwanted API calls from reaching LLMs 325, 340, and 350. Proxies 321 and 326 generate and transfer data that characterizes the API calls and LLM outputs to platform 330. Some examples of computing systems that host proxies 321 and 326 include database systems, server computers, cloud computing platforms, and virtual machines, as well as any other type of computing system, variation, or combination thereof.

On-premises LLM 325, public cloud LLM 340, and private cloud LLM 350 are representative of foundational machine learning models trained to generate recommendations, make predictions, and/or perform some other type of machine learning assisted task. LLMs 325, 340, and 350 comprise examples of LLM 130 illustrated in FIG. 1, however LLM 130 may differ. LLMs 325, 340, and 350 may comprise capabilities to create content, provide market research, provide competitor analysis, serve as general-purpose chatbots, provide customer service, provide translations, generate computer code, provide personalized marketing, provide customer data analysis, provide education recommendations, provide healthcare recommendations, provide financial recommendations, provide legal recommendations, provide media recommendations, provide military/defense recommendations, and/or perform other functions based on natural language inputs. LLMs 325, 340, and 350 generate outputs based on natural language inputs included in API calls generated by user systems 301 or APIs 322-324. The outputs produced by the LLMs typically correspond to the intended function of the LLM. For example, if on-premises LLM 325 comprises an image generation LLM, the output produced by LLM 325 may comprise an image based on the natural language included in the API request. Some examples of computing systems that host LLMs 325, 340, and 350 include database systems, server computers, cloud computing platforms, and virtual machines, as well as any other type of computing system, variation, or combination thereof. It should be appreciated that LLMs 325, 340, and 350 may comprise different types of foundation machine learning models in other examples.

Security platform 330 is representative of an LLM API security platform to determine security policies based on API/LLM output data received from security proxies 321 and 326 and enforce the security policies via proxies 321 and 326. Security platform 330 captures the API requests and responses for software applications that connect to a commercial Generative AI (GenAI) service/LLM(s) via API. By being able to inspect the nature, sequence, and volume of API calls made to the GenAI/LLM(s), security platform 330 may implement detection and mitigation controls in real-time against various attack types.

Computing system 331 in platform 330 may comprise servers, cloud computing systems, or any other computing system, network equipment, apparatus, system, or systems that may connect to another computing system over a communication network. Computing system 331 comprises an example of processing circuitry 120 illustrated in FIG. 1, however processing circuitry 120 may differ. Some examples of computing system 331 include database systems, desktop computers, server computers, cloud computing platforms, and virtual machines, as well as any other type of computing system, variation, or combination thereof.

LLMs and other foundational models face a wide array of security challenges. Since many LLMs utilize APIs to interface with customers, LLMs are often vulnerable to the same types of security vulnerabilities that APIs experience. Exemplary security vulnerabilities that may impact LLMs include sensitive data leakage, prompt injection attacks, data poisoning, insecure output handling, denial of service, permission issues, excessive agency, insecure plugins, and the like.

LLMs are trained on vast datasets sourced from the public domain as well as proprietary information. As such, there is a substantial risk of the models inadvertently learning and then exposing sensitive information in their outputs resulting in sensitive data leaks. This includes Personal Identifiable Information (PII), financial details, health records, and confidential business information, leading to breaches of privacy and compliance violations.

Prompt injection vulnerabilities in LLMs utilize specially crafted inputs that lead to undetected manipulations. The impact ranges from data exposure to unauthorized actions by the LLM that serve the attacker's goals. Malicious actors may craft and submit prompts that manipulate LLMs into generating outputs that serve the attackers' objectives. These prompt injection attacks can lead to unauthorized access to information, dissemination of misinformation, and the LLM behaving in unintended or harmful ways. The open-ended nature of LLM interactions makes this a particularly insidious threat, as it can be challenging to predict and mitigate all possible malicious inputs.

LLMs learn from large and diverse texts but risk training-data poisoning which leads to user misinformation. Overreliance on AI is a concern. Key data sources include Common Crawl, WebText, OpenWebText, and books. The training process of LLMs is susceptible to data poisoning where attackers intentionally introduce harmful, biased, or misleading data into the training data set. This may skew the model's understanding and output which may lead to biased, incorrect, or harmful responses. Such attacks can degrade the model's performance, undermine user trust, and have serious implications for decision-making processes based on LLM outputs.

Insecure output handling vulnerability is a type of prompt injection vulnerability that arises when a plugin or application blindly accepts an LLM output without proper scrutiny and directly passes it to backend, privileged, or client-side functions. This may lead to Cross Site Scripting (XSS), Cross-Site Request Forgery (CSRF), Server-Side Request Forgery (SSRF), privilege escalation, remote code execution, and can enable agent hijacking attacks.

Denial of service threats occur when an attacker interacts with an LLM in a way that is particularly resource-consuming. The increase in resource consumption degrades the quality-of-service for them and other users and/or causes high resource costs to be incurred. Permission issues occur due to a lack of authorization tracking between plugins and may enable indirect prompt injection or malicious plugin usage, leading to privilege escalation, confidentiality loss, and potential remote code execution. When LLMs interface with other systems, unrestricted agency may lead to undesirable operations and actions. Similar to web-applications, LLMs should not self-police and controls should be embedded in APIs. Plugins connecting LLMs to external resources can be exploited if they accept free-form text inputs which enables malicious requests that may lead to undesired behaviors or remote code execution.

These challenges underscore the need for robust security measures in the development and deployment of LLM applications. Addressing these issues utilizes a multi-faceted approach, including data handling and filtering techniques, secure model training practices, and ongoing monitoring and response strategies to identify and mitigate threats. The solutions to these challenges described herein are useful to ensure the safe, ethical, and effective use of LLMs in various applications.

Since LLMs and other foundational models often utilize APIs to interface with customers, it is possible to utilize API based security methods to protect API based LLMs or other API based foundational models from the above discussed security vulnerabilities. LLM API security pipeline 332 is representative of a machine learning powered API based LLM security service implemented computing system 331 to automatically to detect malicious or otherwise unwanted API calls/LLM outputs for LLMs 325, 340, and 350 based on API data received from proxies 321 and 326. LLM API security pipeline 332 generates security policies based on the identified threats to block the unwanted API calls/LLM outputs and deliver the security policies to proxies 321 and 326. LLM API security pipeline 332 comprises an example of security LLM 121 illustrated in FIG. 1, however security LLM 121 may differ. LLM API security pipeline 332 comprises sensitive data detection model 333, prompt analysis model 334, data poisoning model 335, and typically other machine learning models trained to detect additional threats to LLMs 325, 340, and 350. Sensitive data detection model 333 comprises an LLM or other suitable machine learning model trained to detect LLM API calls that drive the LLM to expose sensitive data. Prompt analysis model 334 comprises an LLM or other suitable machine learning model trained to detect LLM API calls that include potentially malicious inputs. Data poisoning model 335 comprises an LLM or other suitable machine learning model trained to screen training data sets utilized by APIs 322-324 to train LLMs 325, 340, and/or 350 to inhibit inclusion of malicious training data. LLM API security pipeline 332 typically includes other models (omitted from FIG. 3 for clarity) trained to detect insecure output handling threats, denial of service attacks, permission issues, excessive agency, insecure plugins, and/or other threats. Alternatively, models 333-335 may be trained to detect these vulnerabilities. Dashboard 336 is representative of a user interface system to display security policies generated by and security vulnerabilities detected by pipeline 332.

The computing systems of user systems 301, gateway 310, API infrastructure 320, APIs 322-324, security proxies 321 and 326, LLMs 325, 340, and 350, and computing system 331, comprise components like processing systems and communication transceivers. The computing systems may include additional components like routers, user interfaces, data storage systems, power supplies, and the like. The computing systems may reside in a single device or may be distributed across multiple devices. The computing systems may be discrete systems or could be integrated within other systems, including other systems within system 300.

In some examples, security reverse proxy 321 receives API calls generated by user systems 301 from gateway 310. The API calls include natural language inputs for LLM 325. Security reverse proxy 321 routes the API calls to APIs 322-324 and/or LLM 325. Similarly, security forward proxy 326 receives API calls generated by operators in infrastructure 320 via APIs 322-324. The operator generated API calls include natural language inputs for LLM 325, public cloud LLM 340, and/or private cloud LLM 350. Security proxies 321 and 326 process their respective API calls to generate API data that characterizes the natural language inputs included in the API calls. Additionally, security proxies 321 and 326 receive API responses generated by LLMs 325, 340, and 350 based on the payloads included in the API calls. Security proxies 321 and 326 process their respective API responses to generate API data that characterizes the natural language (or other) responses included in the API responses. Security proxies 321 and 326 deliver their API data to computing system 331 in security platform 330. The API data indicates the API request payload, API response payload, API metadata, user context, and application context.

Computing system 331 loads the API data as input to security pipeline 332. For example, computing system 331 may generate feature vectors that numerically represent the API data and provide the feature vectors to LLM API security pipeline 332. Pipeline 332 comprises one or more security LLMs (e.g., models 333-335) that are fine-tuned with domain-specific knowledge about APIs, their types, and traffic patterns for enhanced capabilities to identify sensitive data leakage, prompt injection, and the like. The security LLM(s) are trained on a diverse set of API traffic captured during real world operations. The security LLM(s) comprise an understanding of API traffic patterns and behavior, API schema and specifications, API security best practices, and an understanding of sensitive data. In some examples, LLM API security pipeline 332 may utilize a hybrid approach that combines machine learning models and LLMs or Natural Language Processing (NLP) models that are designed to accurately solve a particular problem and trained to understand different aspects of API security, sensitive data, and prompt injection. The hybrid approach results in a comprehensive solution that improves the overall accuracy and coverage of the use cases discussed herein.

Sensitive data detection model 333 ingests the feature vectors. When the API data comprises inputs for LLM training, Sensitive data detection model 333 monitors training datasets accessed via API(s) used by LLMs 325, 340, and/or 350 for training and ensures adequate data sanitization and scrubbing techniques are in place to prevent user data from entering the training model data. Sensitive data detection model 333 may use regex and NLP based models to identify the presence of sensitive data or data that potentially leaks code/data that is considered sensitive or leaking what could be company intellectual property. When the API data comprises inputs generated by user systems 301 for LLMs 325, 340, and/or 350 in production, sensitive data detection model 333 intercepts and monitors all inputs to LLMs 325, 340, and/or 350 by leveraging robust input validation and sanitization methods to identify and filter out potential malicious inputs that seek to extract sensitive data. When the API data comprises inputs generated by operators of API infrastructure 320 for LLMs 325, 340, and/or 350 in production, sensitive data detection model 333 controls vectorized data access by way of vector embeddings based access control techniques to ensure that even in the presence of sensitive data, access to such data by way of queries by end user, is restricted by implementing access-control at the vector embeddings layer to ensure that the data is accessed and utilized in responses only to those queries that contain tokens generated by endpoints with appropriate permissions. Sensitive data detection model 333 produces a machine learning output that identifies sensitive data security threats and includes security policies to mitigate sensitive data leakage.

Prompt injection model 334 ingests the feature vectors. Prompt injection model 334 monitors all inputs to LLMs 325, 340, and/or 350 by leveraging robust input validation and sanitization methods at the API level, to identify and filter out potential malicious inputs/malicious prompt inputs from untrusted sources. Prompt injection model 334 establishes access control boundaries between LLMs 325, 340, and/or 350, external sources, and extensible functionality (e.g., plugins or downstream functions) by way of API access control planes to prevent malicious inputs from plugins/downstream functions. Prompt injection model 334 produces a machine learning output that identifies prompt injection security threats and includes security policies to mitigate prompt injection attacks.

Data poisoning model 335 ingests the feature vectors. When the API data represents inputs for LLM training, data poisoning model 335 monitors training datasets accessed via API(s) used by LLMs 325, 340, and/or 350 for training and ensure adequate data sanitization and scrubbing techniques are in place to prevent unauthorized datasets from being used in the training model data. Data poisoning model 335 produces a machine learning output that identifies poisoned training data security threats and includes security policies to mitigate data poisoning attacks.

Additional models (not illustrated) in pipeline 332 ingest the feature vectors. A model trained to detect insecure output handling performs input validation on responses coming from LLMs 325, 340, and/or 350 to backend functions by inspecting the API call and ensure they conform to compliant controls. The output handling model ensures that the outputs coming from LLMs 325, 340, and/or 350 back to users do not include malicious payloads in the response body, by way of response body analysis. The output handling model produces an output that identifies insecure output threats and includes security policies to mitigate insecure output handling.

A model trained to detect denial of service attacks throttles the number of downstream requests per query/input by rate-limiting based on preset control values and by determining standard input complexity patterns. The denial-of-service model establishes dynamic control-queues for input query calls in response to complex downstream calls as a result of the initial complex input/query. The denial-of-service model produces an output that identifies denial-of-service security threats and includes security polices to mitigate denial of service attacks.

A model trained to detect permission issues blocks every upstream plugin/API/function unless it is performed with explicit authorization. The permission issue model rate-limits the number of concurrent upstream plugin/API/function calls performed by LLMs 325, 340, and/or 350. The permission issue model produces an output that identifies permission issue security threats and that includes security polices to mitigate LLM permission issues.

A model trained to detect excessive agency by LLMs 325, 340, and/or 350 monitors the permissions granted to LLMs 325, 340, and/or 350 to ensure they are not elevated beyond the minimum permission levels applicable. Elevated function calls/API calls are blocked by default. The agency model performs rate-limiting against all downstream function calls performed by LLMs 325, 340, and/or 350. The agency model produces an output that identifies excessive agency security threats and that includes security policies to mitigate excessive agency behavior by the LLMs 325, 340, and/or 350.

A model trained to detect insecure plugins performs type and range checks along with parameterization checks. Any non-conforming API call is be blocked by default. The plugin model produces an output that identifies insecure plugin security threats and incudes security policies to mitigate insecure plugins.

LLM API security pipeline 332 provides the security polices generated by its constituent models to dashboard 336 and to security proxies 321 and 326. Dashboard 336 displays a user interface for operators of security platform 330 that indicates the recommended security policies and detected security vulnerabilities. Security proxies 321 and 326 receive the security policies generated by LLM API security pipeline 332. Security proxies 321 and 326 block malicious or unwanted API calls and received from user systems 301 or generated within API infrastructure 320 based on the security policies. Security proxies 321 and 326 also block malicious or unwanted LLM outputs and generated by LLMs 325, 340, and/or 350 based on the security policies.

In some examples, system 300 implements process 200 illustrated in FIG. 2, process 500 illustrated in FIG. 5, and/or process 600 illustrated in FIG. 6. It should be appreciated that the structure and operation of system 300 may differ in other examples.

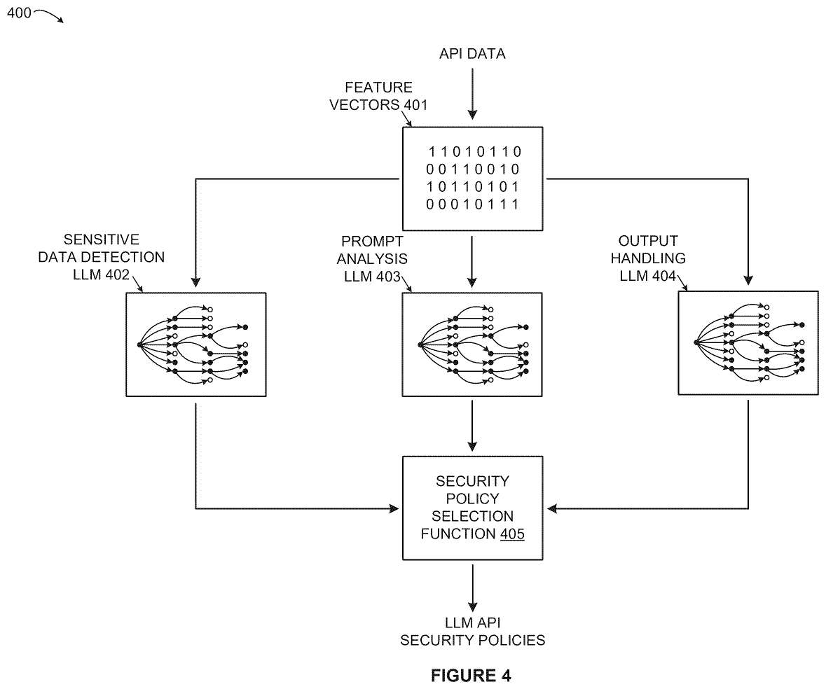

FIG. 4 illustrates LLM API security system 400. LLM API security system 400 comprises an example of system 300 illustrated in FIG. 3 and system 100 illustrated in FIG. 1, however systems 100 and 300 may differ. System 400 comprises feature vectors 401, sensitive data detection LLM 402, prompt analysis LLM 403, output handling LLM 404, and security policy selection function 405. System 400 converts API data that represents the payload of API requests and responses, API metadata, user context, application context, and LLM outputs into feature vectors 401 interpretable by LLMs 402-404. Feature vectors 401 comprise numeric representations of the payload of API requests and responses, API metadata, user context, application context, and LLM outputs that are interpretable by LLMs.

Sensitive data detection LLM 402 ingests and processes feature vectors 401 using its constituent machine learning algorithms. Sensitive data detection LLM 402 produces an output that detects natural language inputs and/or LLM outputs that risk exposing sensitive data or comprise sensitive data. Prompt analysis LLM 403 ingests and processes feature vectors 401 using its constituent machine learning algorithms. Prompt analysis LLM 403 produces an output that detects natural language inputs that may drive an LLM to produce improper or unwanted outputs. Output handling LLM 404 ingests and processes feature vectors 401 using its constituent machine learning algorithms. Output handling LLM 404 produces an output that detects non-complaint LLM API calls and LLM outputs that include malicious or unwanted payloads. LLMs 402-404 provide their outputs to security policy selection function 405. Security policy selection function 405 selects security policies based on the security vulnerabilities detected by LLMs 402-404. Security policy selection function 405 provides the policies to API proxies that screen API calls and LLM outputs for one or more LLMs. For example, security policy selection function 405 may generate policies to block API requests originating from a user system that transferred a large volume (e.g., in excess of a threshold) of API requests with natural language inputs known to expose sensitive data.

FIG. 5 illustrates sensitive data detection process 500. Process 500 comprises an example of process 200 illustrated in FIG. 2, and process 600 illustrated in FIG. 6, however processes 200 and 600 may differ. For example, process 500 may be implemented by system 300 to detect and block API calls that include payloads to drive an LLM to expose sensitive data. Process 500 utilizes a combination of NLP and LLM embeddings to have an exhaustive understanding of sensitive data expressions. The operations for process 500 comprise providing API call 501 and real traffic data 502 to sensitive data detection LLM 503. API call 501 comprises an input prompt for endpoint LLM 504. For example, the prompt may comprise a natural language request to solicit a service provided by endpoint LLM 504. Real traffic data 502 comprises sensitive keywords and sensitive data expressions that may drive endpoint LLM 504 to expose information it is not authorized to expose. Sensitive data detection LLM 503 processes the inputs to determine if API call 501 comprises inputs that may drive endpoint LLM 504 to produce an unauthorized output based on real traffic data 502. When API call 501 comprises allowed inputs, API call 501 is passed to endpoint LLM 504. When LLM 503 determines API call 501 comprises non-allowed inputs, API call 501 is blocked from being sent to endpoint LLM 504 and alert 505 is transferred to the user/LLM operator indicating the security threat.

FIG. 6 illustrates API request and response analysis process 600. Process 600 comprises an example of process 200 illustrated in FIG. 2 and process 500 illustrated in FIG. 5, however processes 200 and 500 may differ. For example, process 600 may be implemented by system 300 to detect and block unwanted API calls/responses associated with an LLM. Process 600 utilizes Retrieval-Augmented Generation (RAG) on an LLM to augment the knowledge about APIs, API specifications, security best practices, API payloads. The LLM is also trained on real world examples of API vulnerabilities and thus has an exhaustive understanding of API traffic patterns and behavior of good as well as bad API configurations. The approach may be used to analyze the input prompts and works for the various use cases discussed herein including data leakage, input/output handling, excessive agency, permission issues, and the like. Documents (e.g., API data 602) related to API posture management and API security best practices are curated from a dataset of real-world examples of good and bad API payloads for various use cases and are converted to embeddings (e.g., specialized embeddings 603). The embeddings are indexed and stored in the vector datastore (e.g., vector store 604) for efficient retrieval. When an LLM query is received (e.g., query 601), the prompt is augmented with multiple checks, each for the various use cases (e.g., sensitive data leak detection, prompt injection attack detection, data poisoning detection, insecure output handling detection, denial of service attack detection, permission issue detection, excessive agency detection, insecure plugin detection, etc.) previously and transformed into a new query. The new query retrieves relevant documents (e.g., retrieve documents 605) related to the questions in the modified query based on the similarity of the documents with the questions of interest. The retrieved documents are aggregated and ranked to produce the final score on how similar this input payload is to prompt injection payloads (e.g., rank documents 606). If the input payload is vulnerable to any data leakage or contains any PII, an alert (e.g., alert 608) is displayed on a dashboard to notify the user. If no threats are identified in the prompt, the prompt is delivered to an external network (e.g., network 607) for delivery to an LLM.

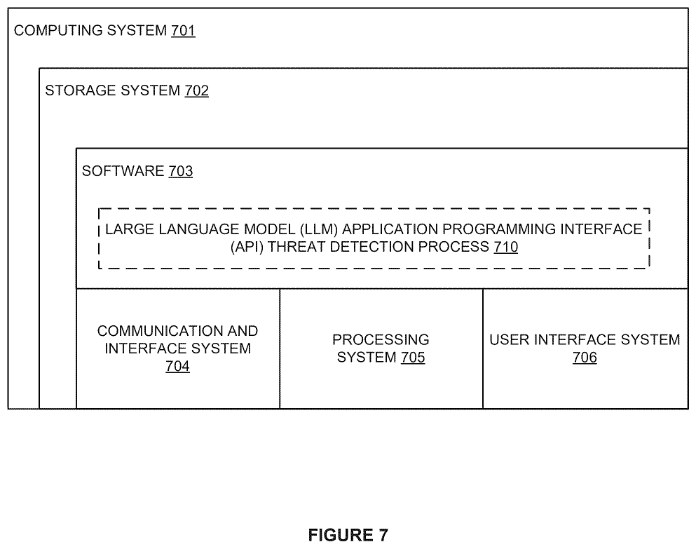

FIG. 7 illustrates computing device 701 which is representative of any system or collection of systems in which the various processes, programs, services, and scenarios disclosed herein to provide API based security for LLMs. For example, computing device 701 may be representative of user device 101, security proxy 110, processing circuitry 120, LLM 130, user systems 301, gateway 310, API infrastructure 320, security platform 330, public cloud LLM 340, private cloud LLM 350, LLMs 402-404, security policy selection function 405, and/or any other computing device contemplated herein. Examples of computing system 701 include, but are not limited to, server computers, routers, web servers, cloud computing platforms, and data center equipment, as well as any other type of physical or virtual server machine, physical or virtual router, container, and any variation or combination thereof.

Computing system 701 may be implemented as a single apparatus, system, or device or may be implemented in a distributed manner as multiple apparatuses, systems, or devices. Computing system 701 includes, but is not limited to, storage system 702, software 703, communication and interface system 704, processing system 705, and user interface system 706. Processing system 705 is operatively coupled with storage system 702, communication interface system 704, and user interface system 706.

Processing system 705 loads and executes software 703 from storage system 702. Software 703 includes and implements LLM API threat detection process 710, which is representative of the processes to provide API based security for LLMs as described in the preceding Figures. For example, LLM API threat detection process 710 may be representative of process 200 illustrated in FIG. 2, process 500 illustrated in FIG. 5, process 600 illustrated in FIG. 6, and/or any other process described herein. When executed by processing system 705, software 703 directs processing system 705 to operate as described herein for at least the various processes, operational scenarios, and sequences discussed in the foregoing implementations. Computing system 701 may optionally include additional devices, features, or functionality not discussed here for purposes of brevity.

Processing system 705 may comprise a micro-processor and other circuitry that retrieves and executes software 703 from storage system 702. Processing system 705 may be implemented within a single processing device but may also be distributed across multiple processing devices or sub-systems that cooperate in executing program instructions. Examples of processing system 705 include general purpose central processing units, graphical processing units, application specific processors, and logic devices, as well as any other type of processing device, combinations, or variations thereof.

Storage system 702 may comprise any computer readable storage media that is readable by processing system 705 and capable of storing software 703. Storage system 702 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 702 may also include computer readable communication media over which at least some of software 703 may be communicated internally or externally. Storage system 702 may be implemented as a single storage device but may also be implemented across multiple storage devices or sub-systems co-located or distributed relative to each other. Storage system 702 may comprise additional elements, such as a controller capable of communicating with processing system 705 or possibly other systems.

Software 703 (including LLM API threat detection process 710) may be implemented in program instructions and among other functions may, when executed by processing system 705, direct processing system 705 to operate as described with respect to the various operational scenarios, sequences, and processes illustrated herein. For example, software 703 may include program instructions for converting API data associated with an LLM into feature vectors and providing the feature vectors to a machine learning model trained to detect security vulnerabilities in the inputs/outputs of the LLM as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 703 may include additional processes, programs, or components, such as operating system software, virtualization software, or other application software. Software 703 may also comprise firmware or some other form of machine-readable processing instructions executable by processing system 705.

In general, software 703 may, when loaded into processing system 705 and executed, transform a suitable apparatus, system, or device (of which computing system 701 is representative) overall from a general-purpose computing system into a special-purpose computing system customized to provide API based security for LLMs as described herein. Indeed, encoding software 703 on storage system 702 may transform the physical structure of storage system 702. The specific transformation of the physical structure may depend on various factors in different implementations of this description. Examples of such factors may include, but are not limited to, the technology used to implement the storage media of storage system 702 and whether the computer-storage media are characterized as primary or secondary storage, as well as other factors.

For example, if the computer readable storage media are implemented as semiconductor-based memory, software 703 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 704 may include communication connections and devices that allow for communication with other computing systems (not shown) over communication networks (not shown). Examples of connections and devices that together allow for inter-system communication may include network interface cards, antennas, power amplifiers, Radio Frequency (RF) circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples provided herein are described in the context of computing devices to provide API based security for LLMs, it should be understood that the systems and methods described herein are not limited to such embodiments and may apply to a variety of other foundational machine learning model security environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method comprising:
obtaining an Application Programming Interface (API) call that is associated with a Large Language Model (LLM);
generating a feature vector that numerically represents data included in the API call associated with the LLM;
providing the feature vector to a security LLM trained to detect security threats to the LLM;
obtaining an output from the security LLM that indicates a security threat to the LLM;
determining a security policy based on the security threat; and
providing the security policy to a security proxy that screens the API call.

2. The method of claim 1 further comprising:
obtaining training data that indicates historical security threats to the LLM;
generating one or more training feature vectors that numerically represent the historical security threats to the LLM;
providing the one or more training feature vectors to the security LLM to train the security LLM to detect the security threats to the LLM;
obtaining a training output from the security LLM that includes a prediction of the historical security threats; and
determining a training state of the security LLM based on an accuracy of the prediction.

3. The method of claim 1 wherein the security threat comprises a sensitive data leak.

4. The method of claim 1 wherein the security threat comprises a prompt injection attack.

5. The method of claim 1 wherein the security threat comprises data poisoning.

6. The method of claim 1 wherein the security threat comprises insecure output handling.

7. The method of claim 1 wherein the security threat comprises a denial-of-service attack.

8. The method of claim 1 wherein the security threat comprises a permission issue.

9. The method of claim 1 wherein the security threat comprises excessive agency.

10. The method of claim 1 wherein the security threat comprises an insecure plugin.

11. A system comprising:
processing circuitry configured to:
obtain an Application Programming Interface (API) call that is associated with a Large Language Models (LLM);
generate a feature vector that numerically represents data included in the API call associated with the LLM;
provide the feature vector to a security LLM trained to detect security threats to the LLM;
obtain an output from the security LLM that indicates a security threat to the LLM;
determine a security policy based on the security threat; and
provide the security policy to a security proxy that screens the API call.

12. The system of claim 11 wherein the security threat comprises a sensitive data leak.

13. The system of claim 11 wherein the security threat comprises a prompt injection attack.

14. The system of claim 11 wherein the security threat comprises data poisoning.

15. The system of claim 11 wherein the security threat comprises insecure output handling.

16. The system of claim 11 wherein the security threat comprises a denial-of-service attack.

17. The system of claim 11 wherein the security threat comprises a permission issue.

18. The system of claim 11 wherein the security threat comprises excessive agency.

19. The system of claim 11 wherein the security threat comprises an insecure plugin.

20. One or more computer-readable storage media having program instructions stored thereon, wherein the program instructions, when executed by a computing system, direct the computing system to perform operations, the operations comprising:
obtaining Application Programming Interface (API) calls addressed for a Large Language Model (LLM) and API responses produced by the LLM;
generating feature vectors that numerically represent data included in the API calls addressed for the LLM and the API responses produced by the LLM;
providing the feature vectors to a security LLM trained to detect security threats to the LLM;
obtaining an output from the security LLM that indicates a security threat to the LLM wherein the security threat comprises at least one of a sensitive data leak, a prompt injection attack, data poisoning, insecure output handling, a denial-of-service attack, a permission issue, excessive agency, or an insecure plugin;
determining a security policy based on the security threat; and
providing the security policy to a security proxy that screens the API calls addressed to the LLM and the API responses produced by the LLM.
